(19) United States
(12) Patent Application Publication
(10) Pub. No.: US 2008/0245833 A1
(43) Pub. Date: Oct. 9, 2008

(54) Clothes Hanging Device For Transporting Clothes in a Passenger Vehicle

(76) Inventor: Jozsef Vacity, Alkotmany u. (HU)

Correspondence Address: YOUNG & THOMPSON, 209 Madison Street, Suite 500, ALEXANDRIA, VA, 22314, US

(21) Appl. No.: 10/583,919

(22) PCT Filed: Dec. 14, 2004
(86) PCT No.: PCT/HU04/00116

§ 371 Date: Sep. 27, 2007

(30) Foreign Application Priority Data
Dec. 22, 2003 (HU) U0300317

(51) Int. Cl. B60R 7/00; A41D 27/22

(52) U.S. Cl. 224/275; 224/543; 224/539; 223/85

(57) ABSTRACT

A clothes hanging for the comfortable transportation of articles of clothing within the interior of a passenger vehicle behind the back and head rests of the seat, includes of a clothes hanger body mounted in fixed fashion to a clothes hanger supporting rod, the lower end of the clothes hanger supporting rod is inserted into a matching fitting. The matching fitting is a pipe-like body of rectangular cross-section with an open upper end, which is built directly, in fixed fashion, into the back rest, at the middle part of the upper end of the back rest of the seat, into which the lower end of the clothes hanger supporting rod, also of rectangular cross-section is inserted with a direct contact, a hook to accommodate the placement of further conventional clothes hangers is mounted to the upper end of the clothes hanger supporting rod that projects beyond the clothes hanger body.

The subject of this invention is a clothes hanging device for transporting clothes in a passenger vehicle, which may be placed behind the back rest of the front seat so that it does not block the driver's view. The clothes hanging device consists of a clothes hanger body, mounted in removable fashion onto the back rest of the seat or head rest supports using a clothes hanger supporting rod and matching fitting, so that the rod may be removed with a single motion and passengers may be transported in the back seat without danger. The fitting is always located below the vertical plane of the head rest, so as to prevent it from becoming the cause of an accident, even in the event of a collision.

It is well known that in the interior of a motor vehicle, certain articles of clothing, such as jackets, coats, etc., are placed on a regular clothes hanger and hung on special hook located above or directly protruding from the overhead safety grips, in order to prevent them from becoming wrinkled. When the vehicle moves, brakes, or accelerates, these articles of clothing generally fall onto the seat or the floor, where they become wrinkled nonetheless. If, on the other hand, a jacket is hung on the same hook by means of the loop sewn at the nape of the neck then this will also cause wrinkling.

Prior art is described by Hungarian patent application HU 222194 for a clothes hanger also used to hang articles of clothing from the overhead grips on the interior of a passenger vehicle. The invention consists of a hanger with one or two supporting arms, a hook disposed between the two supporting arms, and a flexible safety element located inside the opening of the hook in order to partially close the opening, which element leaves the opening of the hook free whenever the spring force is overcome; whereby both supporting arms are fashioned from a first and second piece of wire arranged with a space between them, the outer ends of the pieces of wire are connected, the hook is arranged on the inner ends of the front pieces of wire, and the flexible safety element is fashioned from an additional piece of wire, which connects the inner ends of the other two pieces of wire.

Another invention for hanging up and transporting articles of clothing within the interior of a motor vehicle is described by Hungarian patent specification HU 213765. This invention consists of transport trolleys with a transport rod hung on and slid along a track so that hooks may be hung upon it; a sloping rod that fits to the course of the transport rod and allowing the goods transported to be slid off, and, for receiving the goods from the transport trolleys, a receiving structure located at the upper end of the dispensing rod which may be fit to the transport rod of a transport trolley that has arrived at the proper position for delivering the goods, and which is equipped with a receiving mandrel that projects inward and under the hook, and an upward sloping spike section that lifts each hook that runs onto it down from the transport rod.

The invention serves to transport relatively large quantities of clothing inside motor vehicles, particularly for merchants, using a structure that is complicated, expensive, and functionally unsuited to the transportation by private individuals of one or two articles of clothing in their own vehicles.

In creating the present invention, my objective was to devise a clothes hanging device that may be used in a motor vehicle, which may be placed in simple fashion behind the back rest of the front seat, so that it does not block the driver's field of vision. In the event passengers are also transported in the vehicle, the clothes hanger supporting rod and clothes hanger body may be removed at any time, easily, with a single motion, and since the fitting into which the lower end of the clothes hanger supporting rod is inserted is located below the vertical plane of the head rest, when the clothes hanger supporting rod and clothes hanger body are removed, the remaining fitting will not become the cause of an accident, even in the case of a collision. The device does not interfere with door function, is easy to use, and is safe with respect to both the driver of the vehicle and any passengers in the back seats.

The invention stems from the recognition that if we place a clothes hanging device used for carrying and transporting clothes behind the back rest of the front seat of the motor vehicle, then on the one hand, the hanger and on it the clothes will not disturb the driver of the motor vehicle in the least, nor block his/her field of vision to the sides and rear, while on the other hand, if the clothes hanger body is connected to a fitting, in removable fashion, which itself is mounted, via a clothes hanger supporting rod, into the back rest of the seat or onto the head rest supports so that it may be removed easily using a single motion, then passengers may be transported in the back seat without the danger of accident, and if the fitting that remains on the back rest or head rest supports after the clothes hanger body has been removed is located below the vertical plane of the head rest, then the device will not represent a danger to an individual in the back seat, even in the event of a collision, and thus the invention will meet the set objectives in every respect.

The subject of this invention is a clothes hanging device to be used particularly for placing articles of clothing within the interior of a passenger vehicle comfortably behind the back and head rests of the seat, which device consists of a clothes hanger body that is mounted in fixed fashion to a clothes hanger supporting rod, the lower end of which is inserted into a matching fitting. In another embodiment of the clothes hanger according to this invention, the matching fitting is a pipe-like body of rectangular cross-section, into which the clothes hanger supporting rod, also of rectangular cross-section, is fit.

In another embodiment of the clothes hanging device according to this invention, the matching fitting is mounted directly, in fixed fashion, onto the upper part of the back rest of the seat.

In a third embodiment of the clothes hanging device according to this invention, the matching fitting is mounted in fixed fashion to a telescopically constructed connecting piece that connects the two head rest support rods.

In a further embodiment of the clothes hanging device according to this invention, a hook serving to accommodate the placement of further conventional clothes hangers is mounted to the upper end of the clothes hanger supporting rod that projects beyond the clothes hanger body.

The possible embodiments of the clothes hanging device according to this invention are described through drawings, where:

FIG. 1 is a rear view of the clothes hanging device according to this invention,

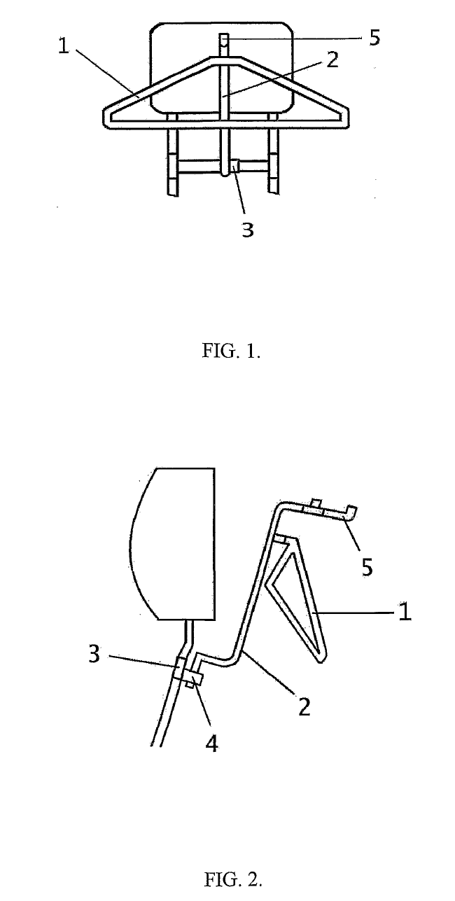

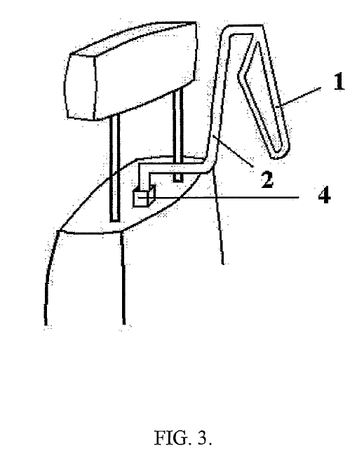

FIG. 2 is a side view of the embodiment involving a connecting piece between head rest support rods, and

FIG. 3 depicts the placement of the matching fitting of the clothes hanging device according to this invention and the manner in which the clothes hanger supporting rod is inserted into it.

FIG. 1 shows how the major parts of the clothes hanging device are positioned after the device has been mounted onto the head rest supports. Visible in this diagram are the clothes hanger body 1, consisting of a conventionally fashioned triangular element equipped with a trousers rack; the clothes hanger supporting rod 2, which is attached to the clothes hanger body 1 at approximately the two-thirds point of its length; and the connecting piece 3, which is mounted at its ends to the head rest supports and the length of which may be set telescopically to accommodate various makes of passenger vehicle. Each end of the connecting piece 3 is attached to the head rest support by means of a pipe-like body that is pulled like a sheath over the support rod.

FIG. 3 clearly shows the matching fitting 4, disposed in fixed fashion on the connecting piece 3, into which the lower end of the clothes hanger supporting rod 2 is inserted such that the clothes hanger supporting rod 2 may be removed from behind the head rest with a single motion when no longer needed.

FIG. 2 shows how the clothes hanging device is positioned behind the head rest. The Z-shaped profile of the clothes hanger supporting rod 2 is clearly visible, as is the manner in which the clothes hanger body 1, on which articles of clothing are placed, is arranged behind the head rest so that it does not obstruct the driver's field of vision. The diagram also clearly depicts the construction of the matching fitting 4 disposed on the connecting piece 3 and located below the back vertical plane of the head rest so that after the clothes hanger supporting rod 2 has been removed, a passenger may be transported safely in the back seat, and is in no danger of an accident even in the case of a collision. Also visible in the diagram is the role of the hook 5 disposed at the upper horizontal section of the clothes hanger supporting rod 2, which is attached to the clothes hanger supporting rod 2 in fixed fashion. An additional number of conventional clothes hangers may be hung on the hook 5 so that they are parallel with the clothes hanger body 1 and, as with the clothes hanger body 1, do not obstruct the driver's field of vision.

FIG. 3 is a graphic representation of a second construction of the matching fitting (4), which is mounted in fixed fashion onto the upper part of the back of the seat. The matching fitting (4) is a pipe-like structure of rectangular cross-section, into which the lower end of the clothes hanger supporting rod (2), of a smaller rectangular cross-section, is inserted so that it may be removed with a single motion when it is no longer needed and so that the matching fitting (4) remaining on the upper portion of the back rest allows for the safe transport of a passenger in the back seat. The rectangular structure of these pieces prevent the clothes hanger supporting rod (2) from rotating out of position.

I have already described the possibilities for using the clothes hanger device according to this invention in the introductory section to this specification, stating my objectives, which have been duly met, with reference to the same. The advantages afforded by the solution according to this invention are the following:
The clothes hanging device which holds the articles of clothing to be transported is disposed within the vehicle's interior behind the head rest of the front seat so that it does not obstruct the driver's view;
The device may be easily removed with a single motion when it is no longer needed and thus the persons travelling in the back of the vehicle are spared from any danger to their safety.
The connecting piece, or, in another embodiment, the matching fitting remaining on the upper part of the back rest of the front seat, may be a cause for accident not even in the case of a collision, because of the manner in which it is disposed below the back vertical line of the head rest.
The clothes hanging device is preferably made of metal or flexible plastic.

### KEY TO DIAGRAMS

1 clothes hanger body
2 clothes hanger supporting rod
3 connecting piece
4 matching fitting
5 hook

1-5. (canceled)

6. A cloth hanging device used particularly for the comfortable transportation of articles of clothing within the interior of a passenger vehicle behind the back and head rests of the seat, consisting of a clothes hanger body (1) which is mounted to a clothes hanger supporting rod (2), the lower end of the clothes hanger supporting rod is connected to a matching fitting (4) whereby the matching fitting (4) is a pipe-like body with an open upper end which is built directly in fixed fashion into the back rest at the middle part of the upper end of the back rest of the seat, at the part between the two head rest support rods, that connects the two head rest support rods, into which the lower end of the clothes hanger supporting rod (2), is inserted with a direct contact.

7. The clothes hanging device according to claim 6, whereby the matching fitting (4) is a pipe-like body of rectangular cross-section, into which the clothes hanger supporting rod (2), also of rectangular cross-section, is inserted.

8. The clothes hanging device according to claim 6, whereby a hook (5) to accommodate the placement of further conventional clothes hangers is mounted to the upper end of the clothes hanger supporting rod (2) that projects beyond the clothes hanger body (1).

9. The clothes hanging device according to claim 7, whereby a hook (5) to accommodate the placement of further conventional clothes hangers is mounted to the upper end of the clothes hanger supporting rod (2) that projects beyond the clothes hanger body (1).
